(19) United States
(12) Patent Application Publication
(10) Pub. No.: US 2012/0024239 A1
(43) Pub. Date: Feb. 2, 2012

(54) Canine Vest

(76) Inventor: William Charles Forbes, Penryn, CA (US)

(21) Appl. No.: 13/195,782

(22) Filed: Aug. 1, 2011

Related U.S. Application Data
(60) Provisional application No. 61/400,592, filed on Jul. 30, 2010.

(51) Int. Cl. A01K 13/00; A01K 29/00

(52) U.S. Cl. 119/850; 119/863

(57) ABSTRACT

The present invention provides a device for wearing by an animal. The device is a vest that includes a back, front and chest portion, and a first and second connection systems disposed on the back, front and chest portions, wherein the back front and chest portions are removably connected via the first and second connection systems. The device further includes a ballistic panel, wherein at least one of the back, front and chest portions includes an internal cavity and the ballistic panel is removably disposed in the internal cavity. Each of the back, front and chest portions are separately and selectively replaceable with a replacement portion.

### CROSS REFERENCE TO RELATED APPLICATION

This application is a nonprovisional application of U.S. Provisional Application No. 61/400,592 filed on Jul. 30, 2010, and this application claims priority to that application and that application is incorporated in its entirety herein by reference.

### BACKGROUND OF THE INVENTION

1. Field of Invention

The present invention relates generally to a canine ballistic vest and rappel device. Particularly, the present invention relates to a device that is placed on a dog to (1) protect the dog from injury from bullets or shrapnel and (2) to allow the dog to be airlifted by or rappel from a helicopter quickly and effectively.

2. Description of Related Art

Ballistic vests are used by law enforcement and military personnel, and others to mitigate the damage done by projectiles impacting the body of the individual wearing the vest. Ballistic vests have been made to be worn by dogs who are trained as law enforcement and military personnel.

Dogs who are trained as law enforcement and military personnel often need a secure harness. The harness can be used for restraining the animal or for military purposes, a secure harness can be necessary to airlift a dog out of a dangerous situation quickly, or to rappel a dog into a military situation with other human military personnel.

Early canine ballistic vests were merely ballistic panels placed on the dog and strapped on. Due to the movement of the dogs, the vests were not secure and would often move and be ineffective and uncomfortable for the dog.

To make the vests more secure, other canine vests are made to surround the entire body of the dog with a vest made of a single unitary member. In these devices, the front legs of the dog are placed in holes in the vest panels. This makes the vests more secure on the dog, however, it creates two other problems. One problem is that the vests with the holes for the legs makes it difficult to put the vest on the dog. It becomes necessary to pull the dog's leg through the holes which is difficult for the human and uncomfortable for the dog. The other problem with the vests with the holes in the panels is that when the dog gains or loses weight, or the vest is placed on a smaller or larger dog, the leg holes cannot be adjusted for the differing size of the dogs' legs.

Still other ballistic vests were made to include a harness both for restraining the dog and for airlifting and rappelling the dog from a helicopter. For a harness to be safe to airlift or rappel a dog, it must be very securely fit on the dog. When Dogs are airlifted off of the ground they feel a loss of gravity and their body begins an instinctive swim motion. The ballistic vests with the harness often only include one or two straps that go around the dog's back legs. The instinctive swim motion can kick the dog's legs out of the back leg straps. In addition the one or two straps around the dog's leg are often tight around the dog's groin area. This can cause discomfort to the dog during rappelling and airlift operations.

Therefore, there remains a need for a securely fit canine ballistic vest that is quick and easy to place on the dog with a harness that is secure enough that the dog's back legs will not slip out of the harness nor cause extreme discomfort to the dog's groin area during reppelling.

### SUMMARY OF THE INVENTION

It is an object of the present invention to overcome the drawbacks and shortcomings of conventional canine ballistic vests. Particularly, the present invention provides a canine ballistic vest that is quick and easy to place on a dog; easy to make fine tune adjustments to all head and arm openings so that it is both comfortable for the dog, securely placed on the dog, and can easily be moved from one size dog to another size dog; and includes a back leg tether on the harness part of the vest that removes the discomfort to the dog's groin area and to ensure that the back legs of the dog do not slip out of the harness during airlift or rappel.

The present invention provides a device that is quick and easy to place on a dog. The device includes three sections a chest section, a back section and a front section. These sections are removably attached by large hook and loop fasteners. The intersections of the three sections form the three holes for the dog's head and two front legs. Therefore the three sections can be partially removed from each other and easily placed on the dog and then easily reattached to each other around the dog's front legs and head. There is no need to pull the dog's legs or head through any tight holes. This is both more comfortable for the dog, and easier for the user, so that there is no struggles between the user and the dog. A secondary connection system is also provided to connect the sections of the vest. The secondary connection system includes straps, which are fixed to the vest. The straps buckle to each other, further securing the vest to the dog quickly and easily.

The present invention provides a device that is personally fit to each dog that uses it. The three sections of the device intersect to form the three holes for the dog's head and two front legs. The large hook and loop fastener allows the user to move the sections together or apart in minute increments, allowing for the perfect fit around the dog's head, each leg, and the torso. This provides a device that is both comfortable for the dog, and securely fit to the dog, and easily changed from one dog to another. The straps on the vest can also be adjusted easily to further secure the dog firmly and comfortably.

Further, the present invention provides a device that includes a harness that includes rear leg straps and a tether to further secure the harness to the dog during airlift and rappel. The harness includes the two rear leg straps that go around each of the dog's rear legs. Those rear leg straps are attached to a tether. The tether keeps the leg straps tight to the legs of the dog in a position which keeps the dog's legs from slipping or kicking out while the dog is rappelling or being airlifted. By keeping the leg straps tight to the legs of the dog, this keeps the straps away from groin area of the dog.

This invention overcomes the drawbacks and shortcomings of the prior art conventional devices.

The present invention further provides a device for wearing by an animal. It is preferred that the animal be a dog. The device in an exemplary embodiment is a vest or harness that includes: a back, front and chest portions; and, a first and second connection systems disposed on the back, front and chest portions, wherein the back front and chest portions are removably connected via the first and second connection systems. In other embodiments, the vest includes a ballistic panel, wherein at least one of the back, front and chest portions includes an internal cavity and the ballistic panel is removably disposed in the internal cavity. In yet other embodiments, the devices includes a repelling harness having a leg strap having first and second ends and a tether having first and second ends, wherein the first end of the leg strap is removably attached to the back portion, the second end of the leg strap is removably attached to the front portion, the first end of the tether is removably attached to the back portion and the second end of the tether is slidably attached the leg strap. Further embodiments entailing having a back portion that includes a front edge, a rear edge and a spine section extending from the front edge to the rear edge and wherein the first end of the leg strap is removably attached adjacent the rear edge and the first end of the tether is removably attached adjacent the spine section. Additional embodiments have a canine vest device wherein each of the back, front and chest portions are separately and selectively replaceable with a new replacement portion having a different size than the back, front and chest portions. Further some of the canine vest devices of the present invention include back, front and chest portions that are separately and selectively replaceable with a new replacement portion. Still further, additional embodiments include devices wherein the first connection system includes a plurality of engagement patches with hook and loop fasteners. Other embodiments includes a canine vest device, wherein the second connection system includes a plurality of straps and a buckle having male and female components, wherein the plurality of straps is affixed to one of the back, front and chest portions, and wherein at least one of the plurality of straps is connected to the male component of the buckle and another strap of the plurality of straps is connected to the female component of the buckle. Additional embodiments have a canine vest device wherein the first connection system includes a plurality of fasteners operably configured for rapid connection of the back, front and chest portions and wherein the second connection system includes a plurality of fasteners operably configured to secure the connection of the back, front and chest portions. Still further in other embodiments, a device is provided wherein the back, front and chest portions define a plurality of openings operably configured to fit about various body parts of the animal.

Still further, the present invention provides a device for four-legged animals, comprising: a vest having a first, second and third bodies; and, a connection system having a plurality of members, wherein each of the first, second and third bodies is attached to at least one of the plurality of members, and wherein the first, second and third bodies are removably connected to each other with the connection system. In other exemplary embodiments, the device further includes a panel, wherein at least one of the first, second and third bodies includes at least two layers that define an cavity and wherein the panel is removably disposed in the cavity. Additional alternative embodiments include a second connection system having a plurality of second connecting members, wherein each of the first, second and third bodies is attached to at least one of the plurality of second connecting members, and wherein the first, second and third bodies are removably connected to each other with the second connection system. Other alternative embodiments include a device, wherein the plurality of members of the connection system includes hook and loop fasteners operably configured for rapid connection of the first, second and third bodies, and wherein the second connection system includes a plurality of fasteners operably configured to secure the connection of the first, second and third bodies. Still further provided in other embodiments is a device wherein the plurality of second connecting members includes a plurality of straps and buckles. The invention also provides a device wherein each of the first, second and third bodies are separately and selectively replaceable with a new replacement body. Other alternative embodiments further include a repelling harness having a leg strap having first and second ends and a tether having first and second ends, wherein the first end of the leg strap is removably attached to the first body, the second end of the leg strap is removably attached to the second body, the first end of the tether is removably attached to the first body and the second end of the tether is slidably attached the leg strap. Other embodiments include a device the first body includes a front edge, a rear edge and a spine section extending from the front edge to the rear edge and wherein the first end of the leg strap is removably attached adjacent the rear edge and the first end of the tether is removably attached adjacent the spine section.

The present invention also provides a device for four-legged animals, comprising: a main body having first, second and third removable sections, wherein the first and second removable sections define a body opening, the first and third removable sections define a neck opening, and the first second and third removable sections define first and second fore leg openings; and, a connection system having a plurality of members, wherein each of the first, second and third bodies is attached to at least one of the plurality of members, and wherein the first, second and third bodies are removably connected to each other with the connection system. In other alternative embodiments, the device further includes a second connection system having a plurality of second connecting members, wherein each of the first, second and third removable sections is attached to at least one of the plurality of second connecting members, wherein the first, second and third removable sections are removably connected to each other with the second connection system, and wherein the second connecting members are a different type of fastener than the connecting members of the connection system.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiment of this invention will be described in detail, with reference to the following figures, wherein;

FIG. 1 is a left-rear perspective view of a canine wearing a vest made in accordance with the present invention;

FIG. 2 is a right-front perspective view of the vest of FIG. 1;

FIG. 3 is a left-rear perspective view of the vest of FIG. 1;

FIG. 4 is a right-rear perspective view of a back section of the vest of FIG. 1;

FIG. 5 is a right-rear perspective view of a front section of the vest of FIG. 1; and,

FIG. 6 is a left-front perspective view of a chest section of the vest of FIG. 1.

### DETAILED DESCRIPTION OF THE PREFERRED EMBODIMENTS

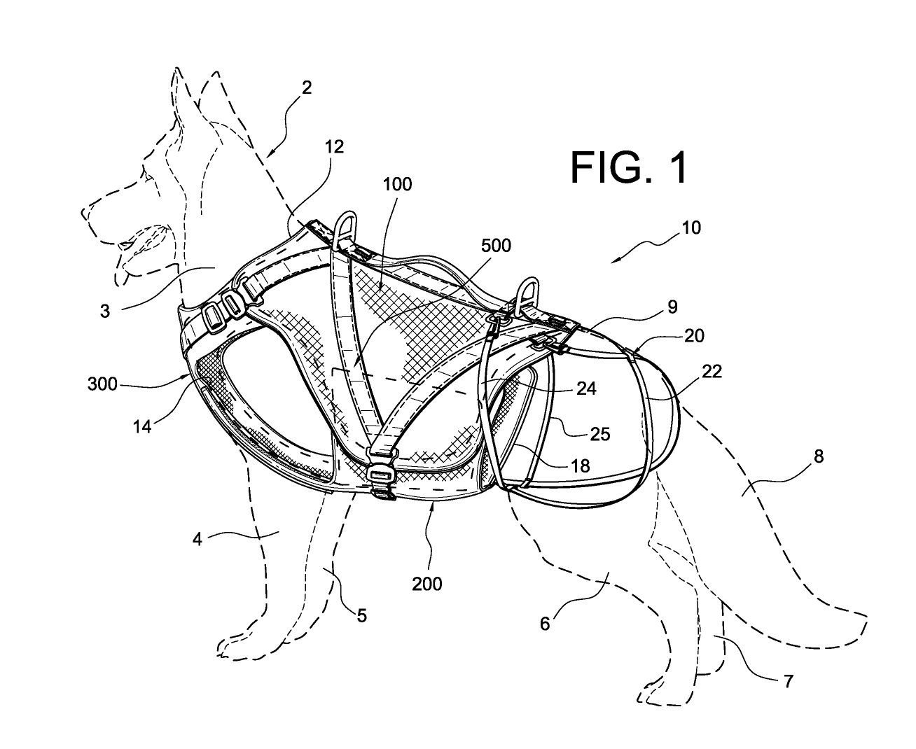

FIG. 1 displays an animal 2 wearing a vest 10, which is an exemplary embodiment of a vest made in accordance with the present invention. In this embodiment, the animal is a dog. It should be appreciated that the vests of the various embodiments of the present invention can be utilized on any four legged animal, provided the components of the vest are sized appropriately, such as for example, a horse.

The vest includes three primary sections or portions, a first portion 100, a second portion 200 and a third portion 300. The portions, 100, 200 and 300 are separate and distinct pieces that are operably configured to be removably affixed to each another during use and operation. These portions can be called components, sections, bodies, or members that make up the devise 10. In this exemplary embodiment, the first portion 100 is a back portion, the second portion 200 is a front portion, and the third portion 300 is a chest portion.

The vest further includes fastener or connection system 400 and fastener or connection system 500, as seen in FIGS. 1-6.

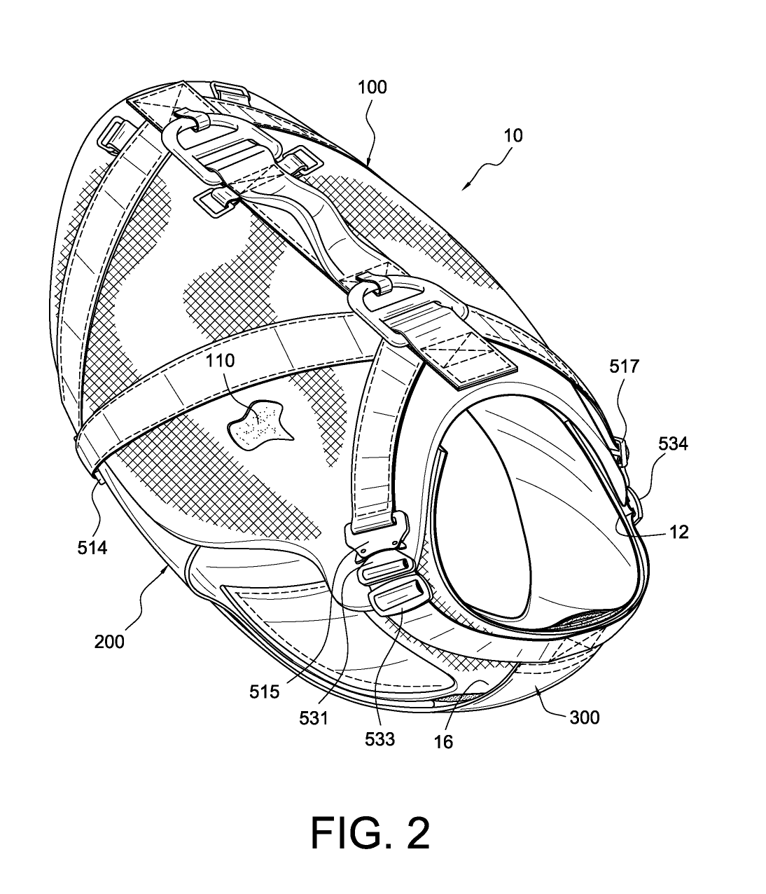

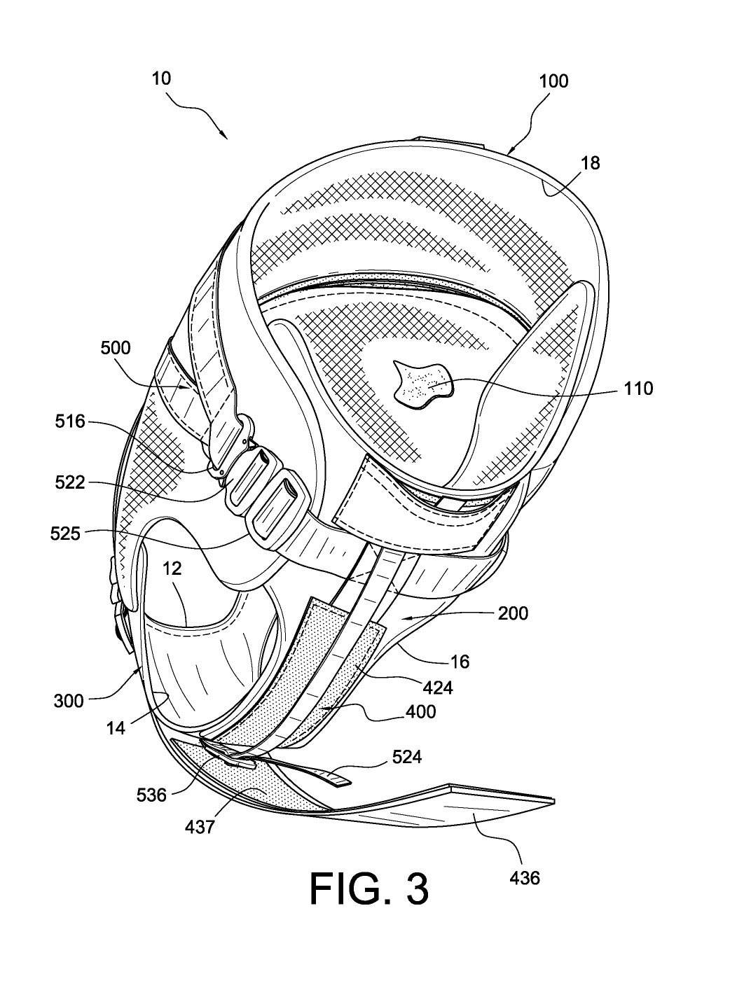

FIGS. 2 and 3 display perspective views of the vest 10. The three portions 100, 200, and 300 together define the body of the vest 10. A plurality of openings are defined by portions 100, 200 and 300. Particularly a neck opening 12 is defined between the first portion 100 and the third portion 300. A dog's neck 3 is disposed within the neck opening 12. A left front leg opening 14 and a right front leg opening 16 is defined between all three portions 100, 200 and 300. A dog's leg 4 is disposed within the left front leg opening 14 and a dog's leg 5 is disposed within the right front opening 16. A hind-end opening is defined between the first portion 100 and the second portion 200.

The device 10 further includes a harness 20 for use with repelling. The harness 20 includes a convention harness strap assembly 22, a left tether 24 and a right tether 25, as shown in FIG. 1. The conventional harness strap assembly 22 is disposed between the dog's hind legs 6 and 7 and around the dog's tail 8.

FIG. 3-6 separately display the three portions 100, 200 and 300, respectively.

Each of the portions 100, 200 and 300 have different shapes but similar configuration. Each portion is preferably made from a durable and flexible material. In this exemplary embodiment, the portions 100, 200 and 300 are preferably a nylon material. It is further preferred that the material be made of a 1000 denier nylon material. A nylon material called Cordura (trademark of Invista) is preferred. It should be understood that other materials and deniers can be employed in other embodiments.

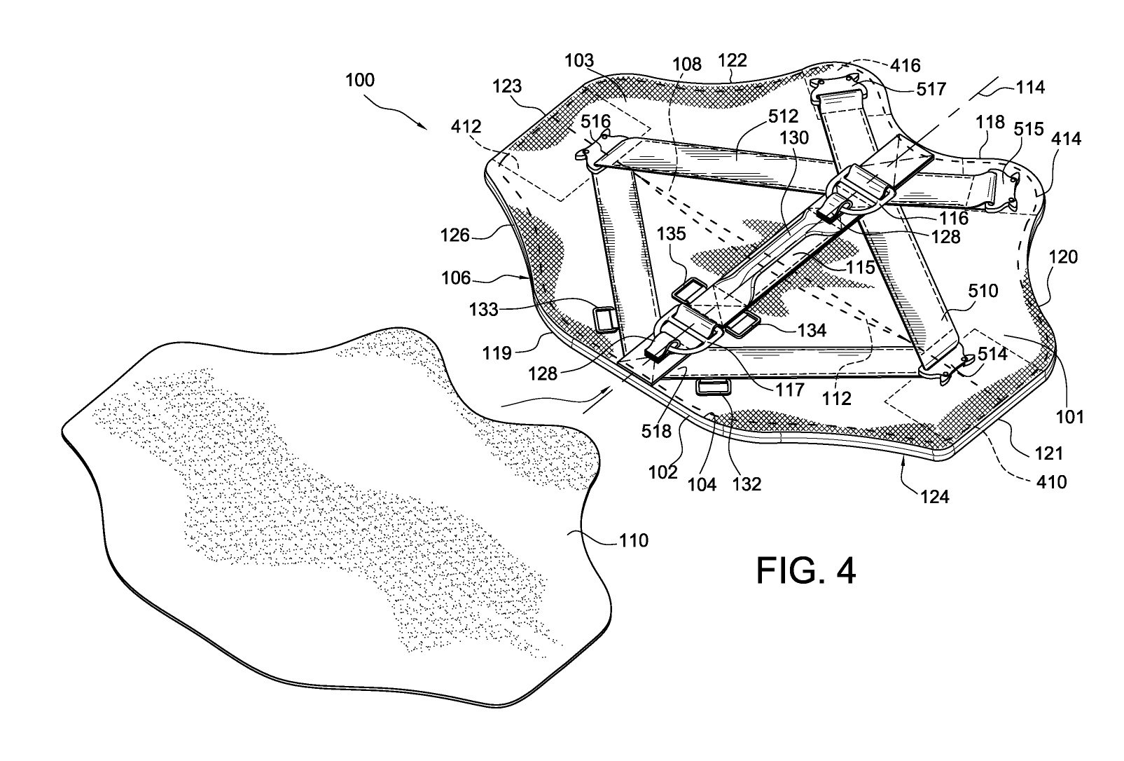

Referring to FIG. 4, the first portion 100 is shown. The portion 100 preferably includes a plurality of layers. In this exemplary embodiment, the portion 100 includes an inner layer 102 and an outer layer 104. The inner and outer layers 102 and 104 are affixed together around a perimeter 106. It is preferred that the layers be sewn together around the perimeter 106. The inner and outer layers or walls 103 and 104 define an interior cavity 108. The first portion 100 preferably includes a first panel 110. The panel 110 is operably configured to be removably disposed within the cavity 108. The panel 110 is sized and shaped so as to readily fit within the internal cavity. The panel 110 is preferably made from known or later developed materials to provide ballistic absorption. It should be appreciated that in other exemplary embodiments, multiple panels are disposed within the cavities of the device. It should be further appreciated that in other exemplary embodiments that the internal cavity is made up of multiple cavities each with separate removable ballistic panels. Further, other types of panels and equipment can be used in other exemplary embodiments other than ballistic panels. For example, stab panels can be utilized for protection against knives and daggers, etc. This type of panel can be employed in a prison environment. Still further, other panels might also include various electronic devices, such as beacons and tracking devices. These other alternative embodiments can also be used in other portions of the vest.

The internal cavity 108 is accessible through an access slot 112. The access slot is disposed along a portion of the perimeter 106. The access slot 112 provides access for the panel 110 to be inserted into the cavity 108. The access slot 112 is selectively sealable through a fastener, not shown. The fastener is located on the inner and outer layers 102 and 104. It is preferred that the fastener is opposing strips of hook and loop fasteners (commercially available as VELCRO, a trademark). Other fasteners are employed in other embodiments, such as but not limited to a zipper.

The first section or portion 100 includes two bodies 101 and 103 divided by a center line 114. The center line 114 is operably configured to generally align with the spine of the dog when the device 10 is in use. A spine reinforcement strap 115 is disposed on the first portion 100. The spine reinforcement strap 115 is preferably disposed long the center line 114. The strap 115 is further preferred to dissect the perimeter 106. The strap 115 is preferably made of nylon. It is preferred that the spine reinforcement strap 115 be made of a two layers of nylon webbing, one layer being a 3 inch nylon webbing and the second layer being a 2 inch nylon webbing.

The first portion 100 includes a D-ring 116 affixed along the spine reinforcement strap 115. The D-Ring 116 is preferably disposed closer to a front portion 118 of the perimeter 106, than a rear portion 119 of the perimeter 106. The D-ring is preferably disposed forward of the center of gravity of the dog when the device 10 is in use. The D-ring 116 is preferably for use during rappelling with the dog. The first portion 100 further includes an optional second D-ring 117 affixed along the spine reinforcement strap 115. The D-ring 117 is similar to the d-ring 116 and is preferably disposed closer to the rear portion 119 of the perimeter 106 than the front portion 118. The reinforcement strap 115 includes at least one hold-down strap 128. In this exemplary embodiment, two hold-down straps 128 are disposed along the strap 115. The hold-down straps 128 are disposed adjacent to the d-rings 116 and 117. The hold-down straps 128 preferably include hook and loop fasteners such that the straps 128 can secure the d-rings 116 and 117 to the first portion 100 when the rings are not in use to prevent them from flopping around.

The perimeter 106 of the first portion 100 defines the overall shape of the portion 100. The perimeter 106 includes the front portion 118 and the rear portion 119. The front portion 118 forms a part of the neck opening 12 of the device 10. The rear portion 119 forms a part of the hind-end opening 18 of the device 10. Adjacent to the front portion 118 is a right front leg portion 120 and a left front leg portion 122. The leg portions 120 and 122 form a part of the leg openings 14 and 16, respectively, of the device 10. The perimeter 106 preferably further includes side portions 121 and 123 disposed adjacent to the leg portions 120 and 122 respectively. Adjacent to the rear portion 119 of the perimeter 106 is a right rear leg portion 124 and a left rear leg portion 126, which are disposed on opposite sides of the rear portion 119. The rear leg portions 124 and 126 and the rear portion 119 form a part of the hind-end opening 18 of the device 10.

The first portion 100 includes a handle 130. The handle 130 is fixed to the spine reinforcement strap 115. It is preferred that the handle 130 be disposed aft or rear of the forward D-ring 116.

The first portion 100 further includes harness attachment rings 132 and 133. The rings 132 and 133 are disposed on opposing sides of the centerline 114. The rings 132 and 133 are operably configured to engage the harness 20 for use with repelling.

The first portion 100 also includes harness tether rings 134 and 135. The rings 134 and 135 are disposed on opposing sides of the centerline 114. The rings 134 and 135 are operably configured to engage the right and left tethers 25 and 24, respectively, of the harness 20.

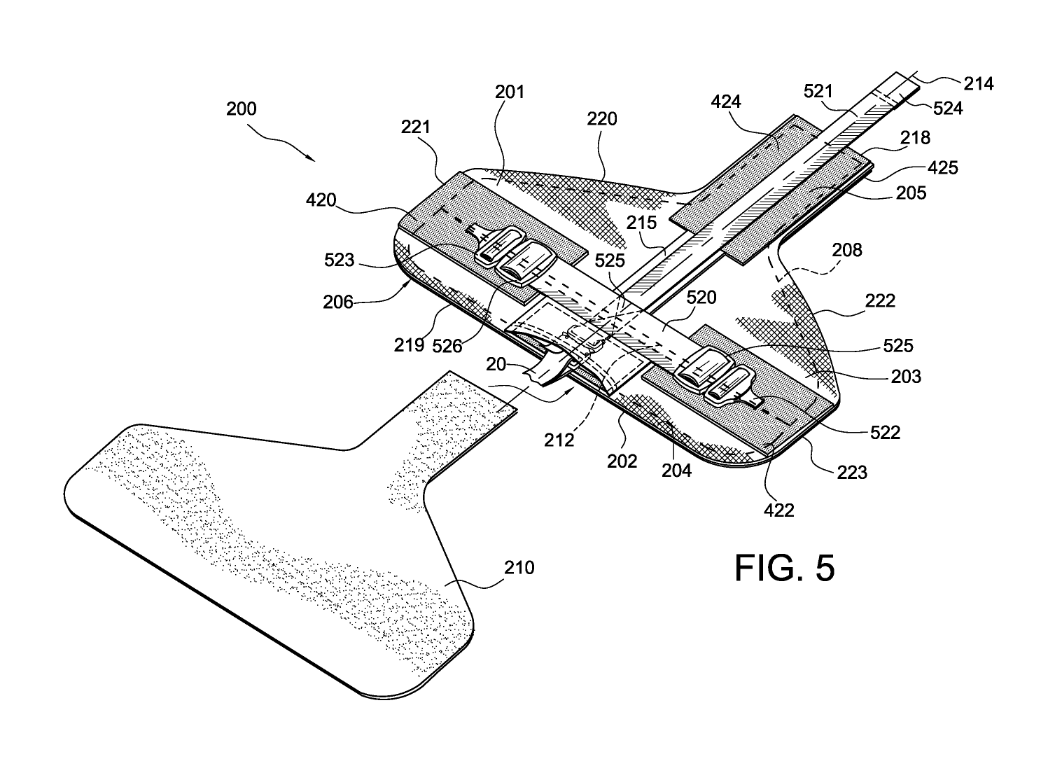

Referring to FIG. 5, the second portion 200 is shown. The portion 200 is configured similar to the first portion 100 described above. The portion 200 includes a plurality of layers. In this exemplary embodiment, the portion 200 includes an inner layer 202 and an outer layer 204. The inner and outer layers 202 and 204 are affixed together around a perimeter 206. It is preferred that the layers be sewn together around the perimeter 206. The inner and outer layers 202 and 204 define an interior cavity 208. The second portion 200 preferably includes a panel 210. The panel 210 is operably configured to be removably disposed within the cavity 208. The panel 210 is sized and shaped so as to readily fit within the internal cavity 208. The panel 210 is preferably made from known or later developed materials to provide ballistic absorption, such as Kevlar (trademark of DuPont Inc.). It should be appreciated that in other exemplary embodiments, multiple panels are disposed within the cavities of the device. It should be further appreciated that in other exemplary embodiments that the internal cavity 208 is made up of multiple cavities each with separate removable ballistic panels.

The internal cavity 208 is accessible through an access slot 212. The access slot is disposed along a portion of the perimeter 206. The access slot 212 provides access for the panel 210 to be inserted into the cavity 208. The access slot 212 is selectively sealable through a fastener, not shown. The fastener is located on the inner and outer layers 202 and 204. It is preferred that the fastener is opposing strips of hook and loop fasteners (commercially available as VELCRO, a trademark). Other fasteners are employed in other embodiments, such as but not limited to a zipper.

The second portion 200 includes three bodies, right and left bodies 201 and 203, and prosternum body 205. The left and right bodies 201 and 203, respectively, divided by a center line 214. The centerline 214 is operably configured to generally align with the sternum and prosternum of the dog 2 when the device 10 is in use. The prosternum body 205 extends from the bodies 201 and 203 along the centerline 214. A sternum reinforcement strap 215 is disposed on the second portion 200. The sternum reinforcement strap 215 is preferably disposed along the centerline 214. The strap 215 is preferably made of nylon and it is preferably 1 inch wide.

The perimeter 206 of the second portion 200 defines the overall shape of the portion 200. The perimeter 206 includes a front portion 218 and a rear portion 219. The rear portion 219 forms a part of the hind-end opening 18 of the device 10. Adjacent to the front portion 218 is a right front leg portion 220 and a left front leg portion 222. The leg portions 220 and 222 form a part of the leg openings 14 and 16, respectively, of the device 10. The perimeter 206 preferably further includes side portions 221 and 223 disposed adjacent to the leg portions 220 and 222 respectively.

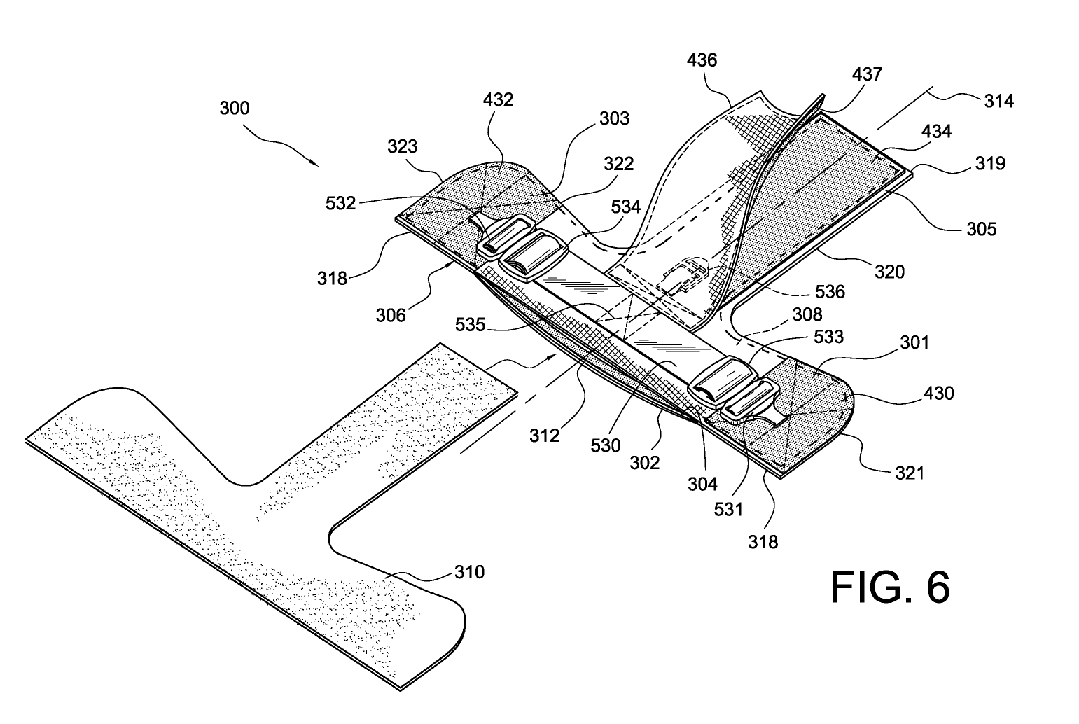

Referring to FIG. 6, the third portion 300 is shown. The portion 300 is configured similar to the first portion 100 described above. The portion 300 preferably includes a plurality of layers. In this exemplary embodiment, the portion 300 includes an inner layer 302 and an outer layer 304. The inner and outer layers 302 and 304 are affixed together around a perimeter 306. It is preferred that the layers be sewn together around the perimeter 306. The inner and outer layers or walls 302 and 304 define an interior cavity 308. The third portion 300 preferably includes a panel 310. The panel 310 is operably configured to be removably disposed within the cavity 308. The panel 310 is sized and shaped so as to readily fit within the internal cavity 308. The panel 310 is preferably made from known or later developed materials to provide ballistic absorption such as Kevlar (trademark of DuPont Inc.). It should be appreciated that in other exemplary embodiments, multiple panels are disposed within the cavities of the device. It should be further appreciated that in other exemplary embodiments that the internal cavity is made up of multiple cavities each with separate removable ballistic panels.

The internal cavity 308 is accessible through an access slot 312. The access slot is disposed along a portion of the perimeter 306. The access slot 312 provides access for the panel 310 to be inserted into the cavity 308. The access slot 312 is selectively sealable through a fastener, not shown. The fastener is located on the inner and outer layers 302 and 304. It is preferred that the fastener is opposing strips of hook and loop fasteners (commercially available as VELCRO, a trademark). Other fasteners are employed in other embodiments, such as but not limited to a zipper.

The third portion 300 includes three bodies, right and left bodies 301 and 303, and prosternum body 305. The left and right bodies 301 and 303, respectively, are divided by a centerline 314. The centerline 314 is operably configured to generally align with the sternum and prosternum of the dog 2 when the device 10 is in use. The prosternum body 305 extends from the bodies 301 and 303 along the centerline 314.

The perimeter 306 of the second portion 300 defines the overall shape of the portion 300. The perimeter 306 includes a front portion 318 and a rear portion 319. The front portion 318 forms a part of the neck opening 12 of the device 10. Adjacent to the rear portion 319 is a right front leg portion 320 and a left front leg portion 322. The leg portions 320 and 322 form a part of the leg openings 14 and 16, respectively, of the device 10. The perimeter 306 preferably further includes side portions 321 and 323 disposed adjacent to the leg portions 320 and 322 respectively.

It should be appreciated that the ballistic panels for the portions 100, 200 and 300 are optional. And further, a panel may be utilized for one portion but not another. The device can be used as a harness when used without the panels. When the ballistic panels are utilized, the device 10 offers a substantial amount of ballistic protection to the dog 2, as the device 10 covers many vital organs of the dog.

The portions 100, 200 and 300 when combined together form the overall vest 10. The vest 10 includes the primary or first fastening system 400, portions of which are shown in FIG. 4 and throughout the FIGS. 1-6. The vest, in this preferred embodiment, further includes the second fastening system 500, portions of which are shown in FIG. 1 and throughout the FIGS. 1-6. The fastening system 400 is separate and distinct from the fastening system 500. Each of the fastening systems 400 and 500 enable the portions 100, 200 and 300 to be removably affixed to each other.

The fastening system 400 preferably includes a plurality of male and female engageable members that enable a user to rapidly affix one of the portions 100, 200 and 300 to another of the portions 100, 200 and 300. Further, the primary fastening system 400 includes the ability to rapidly allow for easy adjustment of the relative positioning between two portions affixed to one another. In this embodiment, the primary fastener system 400 includes a plurality of strips of hook and loop fasteners affixed to areas of each of the portions 100, 200 and 300 of the vest 10.

Referring to FIG. 4, the fastener system 400 includes fastening members, 410, 412, 414 and 416 disposed on the first portion 100. Preferably, the members 410, 412, 414 and 416 are disposed on the inner layer 102 of the portion 100. The member 410 is preferably disposed adjacent the side 121 of the periphery 106 on body 101. The member 412 is preferably disposed adjacent the side 123 of the periphery 106 on body 103. The member 414 is preferably disposed adjacent the front 118 of the periphery 106 on body 101. The member 416 is preferably disposed adjacent the front 118 of the periphery 106 on body 103.

Referring to FIG. 5, the fastener system 400 includes fastening members, 420, 422 and 424, disposed on the second portion 200. Preferably, the members 420, 422 and 424 are disposed on the outer layer 204 of the portion 200. The fastener system 400 further includes fastener 425, disposed on the inner layer 202 of the prosternum body 205 of the portion 200. The member 420 is preferably disposed adjacent the side 221 of the periphery 206 on body 201. The member 422 is preferably disposed adjacent the side 223 of the periphery 206 on body 203. The member 424 is preferably disposed adjacent the front 218 of the periphery 206 on prosternum body 205.

Referring to FIG. 6, The fastener system 400 includes fastening members, 430, 432 and 434, disposed on the third portion 300. Preferably, the members 430, 432 and 434 are disposed on the outer layer 304 of the portion 300. The prosternum body 305 of the portion 300 preferably includes a cover flap 436. The flap is sewn at one end to the portion 300 on the outer layer 304. An under-side of the cover flap 436 includes a fastener member 437. The cover flap 436 is operably configured to cover part of the fastener system 500 that extends along the prosternum body 305. The member 430 is preferably disposed adjacent the side 321 of the periphery 306 on body 301. The member 432 is preferably disposed adjacent the side 323 of the periphery 306 on body 303. The member 434 is preferably disposed adjacent the rear 319 of the periphery 306 on prosternum body 305.

In the preferred embodiment, the fastener member 410, 412, 414 and 416 are the hook type members of a hook and look fastener engagement. The fastener members 420, 422, 424, 430, 432, and 434 are the loop type members of a hook and loop fastener engagement. It should be appreciated that these members could be either the hook or the loop type as long as the opposing fastener is the other type. To connect the vest 10 together, as shown in FIGS. 1, 2 and 3, the following fasteners are operably configured to engage one another: member 410 is engagable with member 420; member 412 is engagable with member 422; member 414 is engagable with member 430; member 416 is engagable with member 432; member 424 is engagable with member 437; and member 425 is engagable with member 434.

Fastener system 400 enables a user to have a vest that can fit a number of different sized dogs. Particularly, the fastener members are engagable along their lengths at an infinite amount of increments, providing substantial flexibility in the sizing of the vest. The sizing of the vest will allow the same vest (i.e. a vest with the same exact portions 100, 200 and 300) to fit a variety of dogs. Further the system 400 enables a user to rapidly don the vest on a dog. Dogs that are in high intensity situations, (situations that generally require a harness or a ballistic vest), tend to be very excited and to be able to simply press the vest portions 100, 200 and 300 together to get them on the dog is invaluable. Further a user could even pre-affix portions of the vest together and leave only one or two of the paired fastener members disengaged and then simply slip the vest over the dog and simply press the remaining paired fastener members together and the user has the vest on the dog in the tense situation in seconds. The vest of the present invention allows the openings in the vest for the dogs body parts to be place around the dog, rather than putting the dogs body parts in holes as other conventional vests require.

The second fastener or connection system 500 includes a plurality of straps disposed on the outer layers of the portions 100, 200 and 300. The plurality of straps are preferably made of nylon. Further, the plurality of straps are preferably 1.75 inches wide to meet current repelling safety requirements. In this embodiment, the second fastener system 500 includes a plurality of straps affixed to areas of each of the portions 100, 200 and 300 of the vest 10, with engagable male and female fasteners or buckles being affixed to the straps. The straps are preferably stitched to the vest at various locations. The stitching is preferably a bartac stitch. The buckles are preferably repelling grade buckles, such as Cobra Buckles (trademark) made by Austri Alpin Inc.

Referring to FIG. 6, the fastener system 500 includes straps 510 and 511 disposed on the first portion 100. The straps are fixed to the portion 100 via stitching at position 518, preferably near the rear portion 119 of the periphery 106. The straps 510 and 511 extend along the length of the portion 100 crossing the center line from one body 101 to the other body 103. Along their lengths, the straps are stitched near their respective mid-points to the portion 100 as well as that the other ends near the front 118 of the periphery 106. Female engagement members 514 and 517 are disposed along the length of strap 510. Preferably the member 514 is disposed adjacent the body 101 near the midpoint of strap 510 and the member 517 is disposed on the strap 510 adjacent the front periphery 118 of the body 103. Female engagement members 516 and 515 are disposed along the length of strap 511. Preferably the member 516 is disposed adjacent the body 103 near the midpoint of strap 511 and the member 515 is disposed on the strap 511 adjacent the front periphery 118 of the body 101.

Referring to FIG. 5, the fastener system 500 includes straps 520 and 521 disposed on the outer layer 204 of the portion 200. The straps 520 and 521 are fixed to the portion 200 via stitching at position 525, preferably near the rear portion 219 of the periphery 206. The strap 520 and 521 are preferably fixed to the portion 200 in a substantially perpendicular relationship to one another along the plane of the portion 200. The strap 520 extends from the body 203 across the centerline 214 to the body 203. The strap 521 is disposed on the portion 200 substantially along the centerline 214. The strap 521 is stitched at point 525, at the end of strap 521, which is preferred to be located at the midpoint of the strap 520. An opposing end 524 of strap 521 extends beyond the front periphery 218 of the portion 200. Male engagement members 522 and 523 are disposed at opposing ends of strap 520. Strap 520 is adjustable along its length through adjustment members 525 and 526.

Referring to FIG. 6, the fastener system 500 includes a strap 530 disposed on the outer layer 304 of the portion 300. The strap 530 is fixed to the portion 300 via stitching at position 535, preferably near the front portion 318 of the periphery 306. The strap 530 extends from the body 301 across the centerline 314 to the body 303. The strap 530 is stitched at point 535, which is preferred to be the midpoint of the strap 530. Male engagement members 531 and 532 are disposed at opposing ends of strap 530. Strap 530 is adjustable along its length through adjustment members 533 and 534. Engagement member 536 is disposed on the prosternum body 305 of the portion 300.

It should be appreciated that although reference to the above fastener member include particular male and female connectors, the other respective connector may be utilized if the corresponding pairing connector is also reversed. To connect the vest 10 together, as shown in FIGS. 1, 2 and 3, the following engagement members are operably configured to engage one another: member 514 is engagable with member 523; member 516 is engagable with member 522; member 515 is engagable with member 531; member 517 is engagable with member 532; and member 536 is engagable with the end 524 of strap 521.

The fastening systems of the present invention allow for the user to arrange the portions and replace the portions to accomplish a continuous spectrum of sizes so that nearly every dog can be fitted with the vest. Further, with having separate components (portions 100, 200 and 300), which are selectively held together by fastening systems 400 and/or 500, different components can be replaced without having to replace the entire vest. This replacement ease provides an enormous economic benefit to the purchaser of the vest. Further, this replacement ease enables even greater size adjustment for a particular dog. Moreover, with the finite adjustment of the vest through the arrangements discussed above, the opening for the legs of the dogs are capable to be fitted appropriately to allow for the maximum range of motion for the dogs limbs and neck. With the maximum range of physical motion being allowed by the vest 10, the vest 10 does not restrict the movement of the dog and thereby allowing the dog to do its job. Even further, having the ballistic panels of the respective portions 100, 200 and 300 being disposed within an interior cavity when they are employed, provides greater comfort to the dog, rather than having the panels in direct contact with the dog. The inner layers of the respective portions 100, 200 and 300 can be made of a material that is comfortable to the dog. Further, in the overlap areas of the portion 100, 200 and 300, more protection for the dog is provided than the non-overlap areas.

Referring to FIGS. 1 & 4 again, the harness 20 includes harness straps 22 and the tethers 24 and 25. The harness straps 22 are removably attached to portion 200 on the rear portion 219 and more preferably adjacent the centerline 214. The harness straps are disposed between the hind legs 6 and 7 of the dog 2 and around the tail 8 as shown in FIG. 1. The harness straps 22 are slidably attached to each other where they cross each other just above the dog's tail 8. The harness straps 22 are removably attached to the rings 132 and 133 of the portion 100. It should be appreciated that in other exemplary embodiments the harness straps may include only a single strap.

The tethers 24 and 25 are slidably engaged at one end with the harness 20 and removably attached at an opposing end to one of the tether rings 134 and 135 of the portion 100. The tethers 24 and 25 prevent the hind legs 6 and 7 of the dog 2 from kicking out of the harness 20 during rappelling operations. The tethers 24 and 25 also pull the harness straps 22 away from the groin area of the dog avoiding unnecessary discomfort to the dog during rappelling and airlifting operations. The harness 20 in other exemplary embodiments is stored in a pocket sewn into the portion 200 and when the user needs the harness, it is readily accessible.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes and combinations thereof may be made without departing from the spirit and scope of this invention.

What is claimed is:

1. A device for wearing by an animal, comprising:
a back, front and chest portions; and,
a first and second connection systems disposed on the back, front and chest portions, wherein the back front and chest portions are removably connected via the first and second connection systems.

2. A device, as recited in claim 1, further comprising a ballistic panel, wherein at least one of the back, front and chest portions includes an internal cavity and the ballistic panel is removably disposed in the internal cavity.

3. A device, as recited in claim 1, further comprising a repelling harness having a leg strap having first and second ends and a tether having first and second ends, wherein the first end of the leg strap is removably attached to the back portion, the second end of the leg strap is removably attached to the front portion, the first end of the tether is removably attached to the back portion and the second end of the tether is slidably attached the leg strap.

4. A device, as recited in claim 3, wherein the back portion includes a front edge, a rear edge and a spine section extending from the front edge to the rear edge and wherein the first end of the leg strap is removably attached adjacent the rear edge and the first end of the tether is removably attached adjacent the spine section.

5. A device, as recited in claim 1, wherein each of the back, front and chest portions are separately and selectively replaceable with a new replacement portion having a different size than the back, front and chest portions.

6. A device, as recited in claim 1, wherein each of the back, front and chest portions are separately and selectively replaceable with a replacement portion.

7. A device, as recited in claim 1, wherein the first connection system includes a plurality of engagement patches with hook and loop fasteners.

8. A device, as recited in claim 1, wherein the second connection system includes a plurality of straps and a buckle having male and female components, wherein the plurality of straps is affixed to one of the back, front and chest portions, and wherein at least one of the plurality of straps is connected to the male component of the buckle and another strap of the plurality of straps is connected to the female component of the buckle.

9. A device, as recited in claim 1, wherein the first connection system includes a plurality of fasteners operably configured for rapid connection of the back, front and chest portions and wherein the second connection system includes a plurality of fasteners operably configured to secure the connection of the back, front and chest portions.

10. A device, as recited in claim 1, wherein the back, front and chest portions define a plurality of openings operably configured to fit about various body parts of the animal.

11. A device for four-legged animals, comprising:
a vest having a first, second and third bodies; and,
a connection system having a plurality of members, wherein each of the first, second and third bodies is attached to at least one of the plurality of members, and wherein the first, second and third bodies are removably connected to each other with the connection system.

12. A device, as recited in claim 11, further comprising a panel, wherein at least one of the first, second and third bodies includes at least two layers that define an cavity and wherein the panel is removably disposed in the cavity.

13. A device, as recited in claim 11, further comprising a second connection system having a plurality of second connecting members, wherein each of the first, second and third bodies is attached to at least one of the plurality of second connecting members, and wherein the first, second and third bodies are removably connected to each other with the second connection system.

14. A device, as recited in claim 13, wherein the plurality of members of the connection system includes hook and loop fasteners operably configured for rapid connection of the first, second and third bodies, and wherein the second connection system includes a plurality of fasteners operably configured to secure the connection of the first, second and third bodies.

15. A device, as recited in claim 13, wherein the plurality of second connecting members includes a plurality of straps and buckles.

16. A device, as recited in claim 11, wherein each of the first, second and third bodies are separately and selectively replaceable with a new replacement body.

17. A device, as recited in claim 11, further comprising a repelling harness having a leg strap having first and second ends and a tether having first and second ends, wherein the first end of the leg strap is removably attached to the first body, the second end of the leg strap is removably attached to the second body, the first end of the tether is removably attached to the first body and the second end of the tether is slidably attached the leg strap.

18. A device, as recited in claim 17, wherein the first body includes a front edge, a rear edge and a spine section extending from the front edge to the rear edge and wherein the first end of the leg strap is removably attached adjacent the rear edge and the first end of the tether is removably attached adjacent the spine section.

19. A device for four-legged animals, comprising:
a main body having first, second and third removable sections, wherein the first and second removable sections define a body opening, the first and third removable sections define a neck opening, and the first second and third removable sections define first and second fore leg openings; and,
a connection system having a plurality of members, wherein each of the first, second and third bodies is attached to at least one of the plurality of members, and wherein the first, second and third bodies are removably connected to each other with the connection system.

20. A device, as recited in claim 19, further comprising a second connection system having a plurality of second connecting members, wherein each of the first, second and third removable sections is attached to at least one of the plurality of second connecting members, wherein the first, second and third removable sections are removably connected to each other with the second connection system, and wherein the second connecting members are a different type of fastener than the connecting members of the connection system.
